(19) United States
(12) Patent Application Publication
(10) Pub. No.: US 2023/0023496 A1
(43) Pub. Date: Jan. 26, 2023

(54) CLEAN-LABEL, PLANT-BASED, HARD-BOILED EGG PRODUCT AND COMPOSITION

(71) Applicant: Anjela Kasper, Malibu, CA (US)

(72) Inventor: Anjela Kasper, Malibu, CA (US)

(21) Appl. No.: 17/865,973

(22) Filed: Jul. 15, 2022

Related U.S. Application Data
(60) Provisional application No. 63/222,242, filed on Jul. 15, 2021.

(51) Int. Cl. A23L 15/00; A23L 19/00; A23L 17/60; A23L 19/12; A23P 30/10; A23J 1/00

(52) U.S. Cl. CPC A23L 15/35; A23L 19/09; A23L 17/60; A23L 19/12; A23P 30/10; A23J 1/006; A23V 2002/00

(57) ABSTRACT

A clean-label, plant-based hard-boiled egg product, that replicates the look and feel of a regular hard-boiled egg by providing a yolk portion and an albumin portion. The yolk portion and the albumin portion provide meaningful nutritional value while replicating a standard hard-boiled egg. The yolk portion may be formed to replace a hard-boiled egg or a deviled egg and molded into the albumin portion to provide the final egg product. The yolk may also be enhanced to form a superfood egg. The future egg product varieties may be used in combination with various plant-based food ingredients by providing the structure, texture and other properties of a hard-boiled egg while serving as a healthier, tastier, ready-to-eat, cruelty-free, and more sustainable alternative to a bird-laid egg.

### CROSS-REFERENCE TO RELATED APPLICATIONS

The present application claims priority to U.S. Provisional Application No. 63/222,242, filed on Jul. 15, 2021.

### BACKGROUND OF THE INVENTION

### 1. Field of the Invention

The present invention relates to food products and, more specifically, to a clean-label, plant-based hard-boiled egg having a similar construction and consistency to a regular hard-boiled egg.

### 2. Description of the Related Art

Bird-laid eggs present challenges which include extensive burden on the environment including the use of large land areas for feed, roaming areas for free-range chickens, large penned and inhumane factories for caged birds in order to limit land use, dealing with extensive waste from the birds for the lifetime of the bird, use of chemicals and antibiotics in order to control disease which ultimately penetrate the food products which are then consumed, a great amount of methane gas produced by the entire process and many more direct issues, such as unhealthy cholesterol and the growing taste and demand for plant-based diets across the world.

Presently, many products have been created to substitute the egg with non-animal content, such as powders that are mixed with water to produce a liquid egg substitute, which then is heated to create scrambled eggs. In other embodiments, pre-shaped egg substitute products have been offered which mimic fried eggs with a yellow portion in the center and a white portion surrounding the yellow portion. US Pub. No. 20210161186 discloses an egg-shaped container that surrounds an “albumen-like” egg white, which then surrounds a yolk based on an emulsified oil base and gelling agents. The content and structure of the egg white as well as the egg yolk is composed mostly of water, however, along with emulsified oils that are unhealthy and artificial gelling agents to create the desired texture. The composition further requires the use of soy ingredients that can have undesirable hormonal activity. While this composition may look like an egg, it does not comprise a meaningful food item. Similarly, U.S. Pat. No. 364,072 discloses an egg substitute formed from an oil-water emulsion and gelling agents that simulates an egg but does not constitute a nutritional food item.

Accordingly, there is a need in the art for a clean-label, hard-boiled egg alternative that uses organic, plant-based ingredients that are sustainable and cruelty-free to provide a healthy food item that can replace both the look and feel of a natural hard-boiled egg while also providing a comparable nutritional value with respect to protein content as well as zero cholesterol and less calories.

### BRIEF SUMMARY OF THE INVENTION

The present invention comprises an all-natural, clean-label, plant-based hard-boiled egg white and egg yolk composition that can be molded to replicate the look and texture of a regular hard-boiled egg, while providing meaningful nutritional value. The present invention can be configured, but not limited to look like a regular hard-boiled egg or a deviled egg, and can be enhanced with components to further enhance the nutritional value to form a superfood egg.

In a first embodiment, the present invention comprises a plant-based hard-boiled egg product having a yolk portion that includes an amount of coconut and an amount of a vegetable selected from the group consisting of squashes, potatoes, carrots, peas, and cashews and an albumin portion surrounding at least some of the yolk portion, wherein the albumin portion includes an amount of coconut milk and an amount of a vegan protein. The yolk portion may further comprise seaweed, black salt, and another vegetable such as squash, potato, carrot, pea, and cashew, or combinations thereof. The yolk portion may also further comprise an amount of algae, an amount of coconut oil, or an amount of lemon. The vegetable may be squash and comprise between 50 and 70 percent of the yolk portion. The vegetable may be potato and comprise between 30 and 60 percent of the yolk portion. The coconut milk may comprise between 50 and 80 percent of the albumin portion. The vegan protein comprises between 10 and 40 percent of the albumin portion.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is an image of a plant-based hard-boiled egg product according to the present invention.

### DETAILED DESCRIPTION OF THE INVENTION

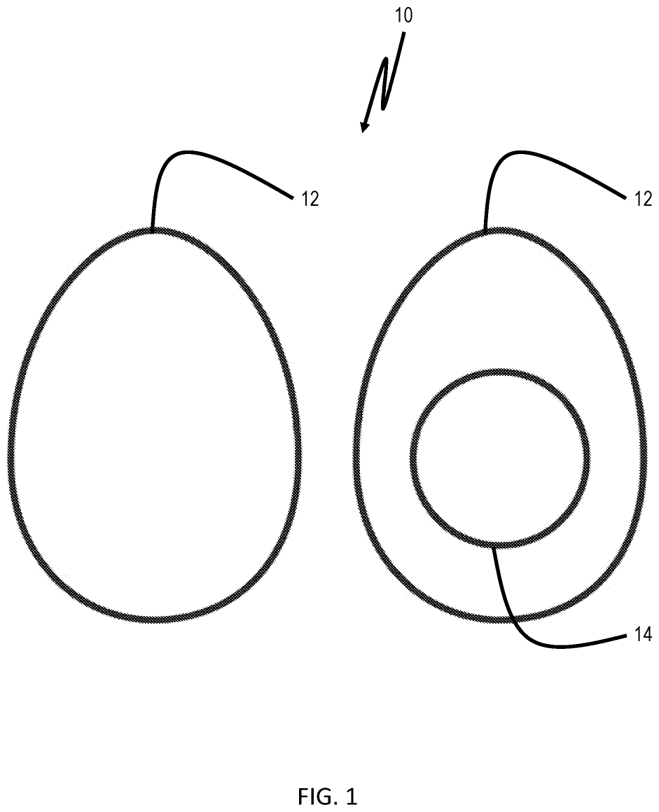

Referring to the figures, wherein like numeral refer to like parts throughout, there is seen in FIG. 1 an all-natural, plant-based hard-boiled egg product 10 that replicates the look and feel of a regular hard-boiled egg by providing a yolk portion 12 and an albumin portion 14 while providing meaningful nutritional value. As described below, the composition of yolk portion 12 and albumin portion 14 may be varied for specific applications. Hard-boiled egg product 10 is described herein in as being manufactured using a food-grade silicone mold that can be opened from the top, with egg product 10 being formed in an upside down configuration. It should be recognized that various types and configuration of molds maybe used, including ones that allow for any desired shape and size. For the purposes of the present invention and the description herein, the term “plant-based” refers to a product that does not contain or is based on any animal products.

As an example, albumin product 14 may be poured into the mold to fill the mold approximately two-thirds. Next, the mold may be opened and yolk portion 12 inserted into the center of albumin product 14. It is not necessary to cool the mold prior to this step. Once yolk portion 12 is in position, the mold may then be closed. The rest of the mold may then be filled with additional albumin product 14. The mold should then be vibrated to release any bubbles in albumin portion 14. The mold and contents should then be cooled to 60 F or cooler. Completed egg products 10 may then be removed from the mold.

### Example 1

In a first embodiment, yolk portion 12 may be configured to replicate a standard hard-boiled egg. Table 1 below provides the preferred organic, nut-free ingredients for forming yolk portion 12 as an Original egg:

TABLE 1

| Content | Amount | Use |
|---|---|---|
| Squash | 50-70% | Nutrition, Texture |
| Coconut | 25-30% | Nutrition, Taste, Texture, Binder |
| Seaweed | 5-10% | Nutrition, Collagen Peptides, Texture, |
| | | Stabilizer (if Kombu, Dulse, Irish Moss) |
| Black salt | 0.01-0.1% | Nutrition, Egg taste and Scent, Food |
| | | Preservative |

In this embodiment, all ingredients are blended until uniform with a temperature range between 50-75 F. The ingredients are removed from the blender and measured to between about 12 to 18 grams for a standard size egg yolk. The measured ingredients are then rolled or formed into yoke-sized spheres and set aside.

### EXAMPLE

In a second embodiment, yolk portion 12 may be configured to replicate a deviled egg. Table 2 below provides the preferred organic, nut-free ingredients for forming yolk portion 12 as a Deviled egg:

TABLE 2
Deviled Egg

| Content | Amount | Use. |
|---|---|---|
| Potato | 30-60% | Nutrition, Taste and Texture, Binder |
| Carrots | 5-15% | Nutrition, Taste, Texture |
| Pickles | 10-30% | Nutrition, Taste and Texture |
| Peas | 5-10% | Nutrition, Taste and Texture |
| Vegan Mayo | 5-15% | Nutrition, Binder, Taste and Texture |
| Dill | 1-3% | Nutrition, Taste and Texture |
| Black salt | 0.1-0.3% | Nutrition, Egg Taste, Scent, Food |
| | | Preservative |

In this embodiment, all ingredients are cubed to desired size at a temperature range of between 50-75 F. Ingredients are measured to between 12-18 grams per egg yolk and then rolled or formed into yoke-sized spheres and set aside.

### Example 3

In a third embodiment, yolk portion 12 may be configured to provide a superfood type yolk. Table 3 below provides the preferred organic, ingredients for forming yolk portion 12 as a Superfood egg:

TABLE 3

| Content | Amount | Use |
|---|---|---|
| Coconut | 25-35% | Nutrition, Taste, Texture, Binder |
| Cashews | 25-35% | Nutrition, Taste, Texture, Protein |
| Low-glycemic | 15-25% | Nutrition, Taste, Food Preservative, Binder |
| Sweetener | | (if Coconut Sugar, Coconut Nectar, Coconut |
| | | Blossom Sugar) |
| Lemon | 10-20% | Nutrition, Taste, Food Preservative, Acidifier |
| Blue Algae | 3-10% | Nutrition, Protein, Superfood Content |
| Concentrate | | |
| Coconut Oil | 25-40% | Nutrition, Binder, Food Preservative |
| | | (optional) |
| Vanilla | 0.1-0.3% | Nutrition, Taste, Scent |

In this embodiment, all ingredients are blended until uniform with a temperature range between 50-75 F. The blended ingredients are removed from the blender, chilled to set, and measured to between 12-18 grams per egg yolk. The measured ingredients are then rolled or formed into yoke-sized spheres and set aside.

### Example 4

In a fourth embodiment, albumin portion 14 may be prepared for use with any of the above Examples. Table 4 below provides the preferred organic ingredients for forming albumin portion 14:

TABLE 4

| Content | Amount | Use |
|---|---|---|
| Coconut Milk | 50-80% | Nutrition, Blending Agent, Texture, Taste (if |
| | | Store-Bought, Home-Made) |
| Vegan Protein | 10-40% | Nutrition, Additional Protein Content (if Rice |
| | | Protein, Fava Bean Protein) |
| Silica | 0.1-0.4% | Nutrition, Collagen, Mineral Content |
| Black Salt (Original and Deviled | 0.1-0.4% | Nutrition, Egg Taste & Scent, Food |
| Eggs Only) | | Preservative |
| Low-glycemic Vegan Sweetener | 15-25% | Nutrition, Taste, Food Preservative, Binder, |
| (Superfood Egg Only) | | Preservative (if Coconut Nectar, Coconut |
| | | Blossom Sugar, Coconut Sugar) |
| Lemon (Superfood Egg Only) | 3-10% | Nutrition, Taste, Food Preservative, Acidifier |
| Natural Preservative | 0.1-0.5% | Nutrition, Preservative, Mineral Content (if |
| | | Calcium Carbonate, Potassium Sorbate) |
| Vegan Gelling Agent | 0.5-2% | Nutrition, Texture, Stabilizer (if Agar Agar, |
| | | Irish Moss, Carrageenan, Konjac Root, Guar |
| | | Gum) |

In this embodiment, all ingredients are blended, brought to boil, simmered for a few min.

The present invention thus provides both an albumin portion 14 and yolk portion 12 that mainly comprises whole and actual nutritious foods, little to no water, no gluten, no artificial coloring, preservatives, or fillers. The present invention also does not contain any soy products, which have been shown to cause hormonal issues, no non-nutritional oil-in-water emulsions, and no grains, legumes, or cereals. In addition, the present invention is entirely plant-based as no dairy products are used.

What is claimed is:

1. A plant-based hard-boiled egg product, comprising:
a yolk portion that includes an amount of coconut and an amount of a vegetable selected from the group consisting of squash, potato, carrot, pea, and cashew, and combinations thereof; and
an albumin portion surrounding at least some of the yolk portion, wherein the albumin portion includes an amount of coconut milk and an amount of vegan protein.

2. The plant-based hard-boiled egg product of claim 1, wherein the yolk portion further comprises an amount of seaweed.

3. The plant-based hard-boiled egg product of claim 2, wherein the yolk portion further comprises an amount of black salt.

4. The plant-based hard-boiled egg product of claim 3, wherein the yolk portion further comprises an amount of at least a second vegetable selected from the group consisting of squash, potato, carrot, pea, and cashew, and combinations thereof.

5. The plant-based hard-boiled egg product of claim 1, wherein the yolk portion further comprises an amount of algae.

6. The plant-based hard-boiled egg product of claim 1, wherein the yolk portion further comprises an amount of coconut oil.

7. The plant-based hard-boiled egg product of claim 1, wherein the yolk portion further comprises an amount of lemon.

8. The plant-based hard-boiled egg product of claim 1, wherein the amount of the vegetable is squash and comprises between 50 and 70 percent of the yolk portion.

9. The plant-based hard-boiled egg product of claim 1, wherein the vegetable is potato and comprises between 30 and 60 percent of the yolk portion.

10. The plant-based hard-boiled egg product of claim 1, wherein the coconut milk comprises between 50 and 80 percent of the albumin portion.

11. The plant-based hard-boiled egg product of claim 10, wherein the vegan protein is comprises between 10 and 40 percent of the albumin portion.

12. A method of making a plant-based hard-boiled egg product, comprising the steps of:
placing a portion of an albumin product in liquid form into a mold at a temperature above room temperature;
inserting a yolk portion that is in solid form into the albumin portion in the mold;
filling the mold with a remaining portion of the albumin product in liquid form; and
cooling the mold until the albumin product solidifies to form the plant-based hard-boiled egg product.
